(19) United States
(12) Patent Application Publication
(10) Pub. No.: US 2025/0390674 A1
(43) Pub. Date: Dec. 25, 2025

(54) SYSTEMS AND METHODS FOR MAINTAINING CUSTOMER ENGAGEMENT WHILE ENGAGED IN CHATBOT CONVERSATIONS

(71) Applicant: Verizon Patent and Licensing Inc., Basking Ridge, NJ (US)

(72) Inventors: Arindam MITRA, Duluth, GA (US); Mohini L. SURI, Southlake, TX (US); Vipul JHA, Plano, TX (US)

(73) Assignee: Verizon Patent and Licensing Inc., (omitted)

(21) Appl. No.: 18/748,571

(22) Filed: Jun. 20, 2024

(51) Int. Cl. G06F 40/20; H04L 51/02; H04L 67/306

(52) U.S. Cl. CPC G06F 40/20; H04L 51/02; H04L 67/306

(57) ABSTRACT

A device may receive text data associated with a conversation of a user, and may process the text data, with large language models (LLMs), to generate conversation tags. The device may generate user attribute tags based on user data, and may classify the conversation tags and the user attribute tags to generate classified tags. The device may convert the text data and the classified tags to a searchable document, and may process the searchable document and historical tag data, with a statistical model, to identify multiple users that match the user. The device may determine degrees of match between the multiple users and the user, and may identify one of the multiple users based on the degrees of match. The device may utilize the historical tag data associated with the one of the multiple users to generate a response for the user, and may provide the response to the user.

### BACKGROUND

In today's digital era, customer service systems, such as chatbots, are widely used to handle user interactions and inquiries. A chatbot is a software application or web interface that is designed to mimic human conversation through text or voice interactions.

### BRIEF DESCRIPTION OF THE DRAWINGS

FIGS. 1A-1G are diagrams of an example associated with determining patterns and providing feedback for chatbot conversations.

FIG. 2 is a diagram of an example environment in which systems and/or methods described herein may be implemented.

FIG. 3 is a diagram of example components of one or more devices of FIG. 2.

FIG. 4 is a flowchart of an example process for determining patterns and providing feedback for chatbot conversations.

### DETAILED DESCRIPTION OF EXAMPLE EMBODIMENTS

The following detailed description of example implementations refers to the accompanying drawings. The same reference numbers in different drawings may identify the same or similar elements.

Chatbots often struggle to fully understand user requests and provide contextually relevant solutions, leading to disengagement from users who seek assistance from human representatives (e.g., live agents). Furthermore, existing customer service chatbots face challenges in effectively utilizing historical data to predict and meet user needs in real-time conversations, resulting in limited engagement and user satisfaction. Thus, current techniques for utilizing chatbots consume computing resources (e.g., processing resources, memory resources, communication resources, and/or the like), networking resources, and/or other resources associated with failing to properly answer user questions with chatbots, handling user complaints due to failing to properly answer user questions appropriately and efficiently, providing incorrect recommendations based on poorly designed chatbots, providing irrelevant and inaccurate responses based on poorly designed chatbots, and/or the like.

Some implementations described herein provide an agent system that determines patterns of behavior and provides feedback for chatbot conversations. For example, the agent system may provide a chatbot interface to a user via a user device, and may receive text data associated with a conversation of the user via the chatbot interface. The agent system may process the text data, with one or more large language models (LLMs), to generate conversation tags representative of content of the conversation, and may generate user attribute tags based on user data identifying activity and a profile of the user. The agent system may classify the conversation tags and the user attribute tags to generate classified tags, and may convert the text data and the classified tags to a searchable document with a summary and the classified tags. The agent system may process the searchable document and historical tag data, with a statistical model, to identify a plurality of users that match the user (e.g., in terms of activity) based on the historical tag data and the classified tags of the searchable document, and may determine degrees of match between the plurality of users and the user based on the historical tag data and the classified tags of the searchable document. The agent system may identify one of the plurality of users based on the degrees of match, and may utilize the historical tag data associated with the one of the plurality of users to generate a response for the user. The agent system may provide the response to the user via the chatbot interface and the user device.

In this way, the agent system determines patterns and provides feedback for chatbot conversations. For example, the agent system may utilize large language models (LLMs) and data clustering techniques to efficiently manage user chatbot inquiries and reduce workload on live agents. The agent system may synthesize user attribute tags, may generate conversation tags, and may compile conversation content with a concise summary to generate a structured and searchable document. The agent system may process the document and historical tag (e.g., interaction) data with statistical models to correlate a user's inquiry with similar historical instances, allowing for a customized response to the user. The agent system may utilize user feedback to constantly refine the historical tag data and improve future user interactions with the chatbot. By analyzing patterns and preferred interaction styles from the historical tag data, the agent system may optimize user engagement and may reduce the need for direct human assistance. Thus, the agent system may conserve computing resources, networking resources, and/or other resources that would have otherwise been consumed by failing to properly answer user questions with chatbots, handling user complaints due to failing to properly answer user questions appropriately and efficiently, providing incorrect recommendations based on poorly designed chatbots, providing irrelevant and inaccurate responses based on poorly designed chatbots, and/or the like.

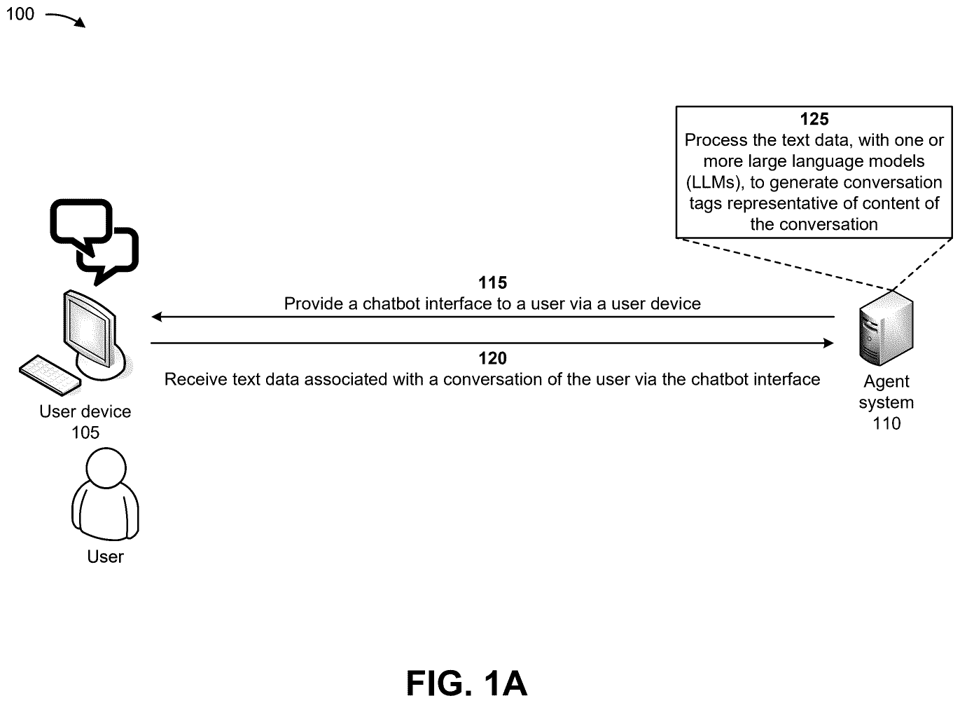

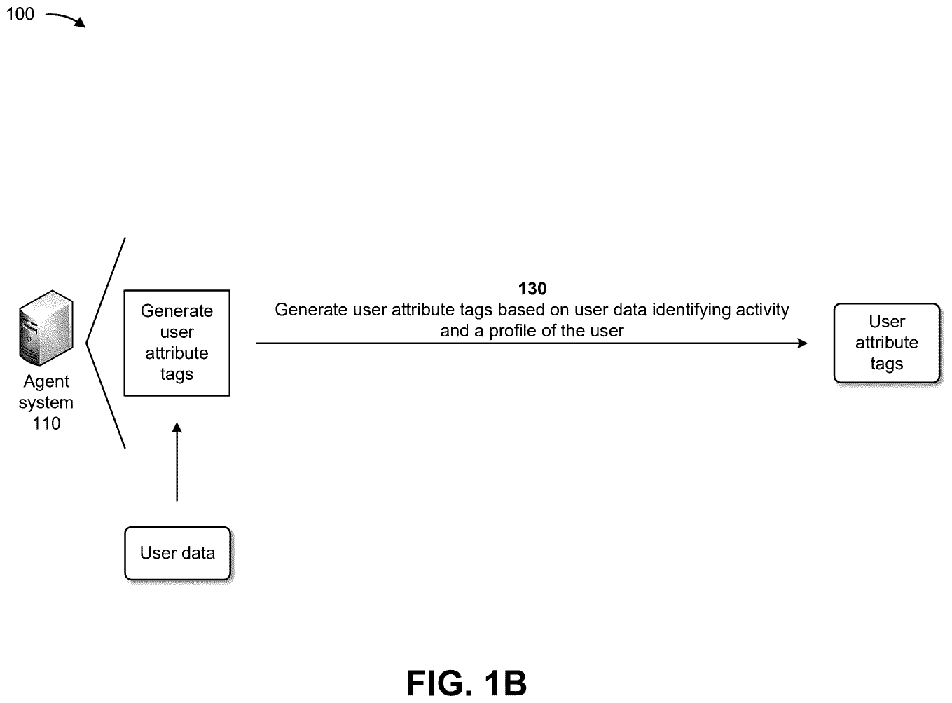

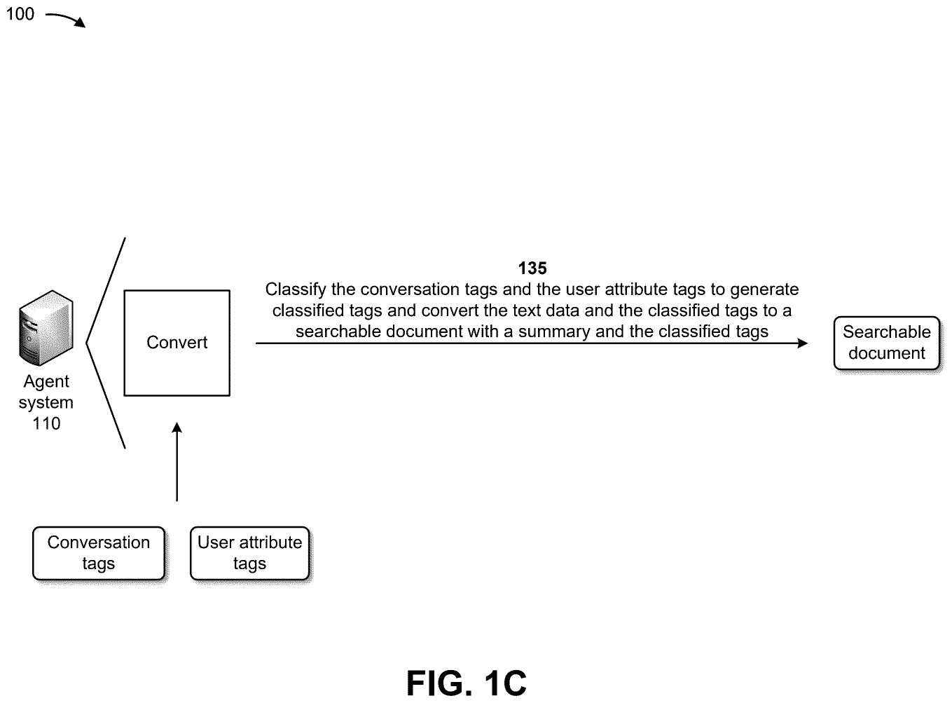

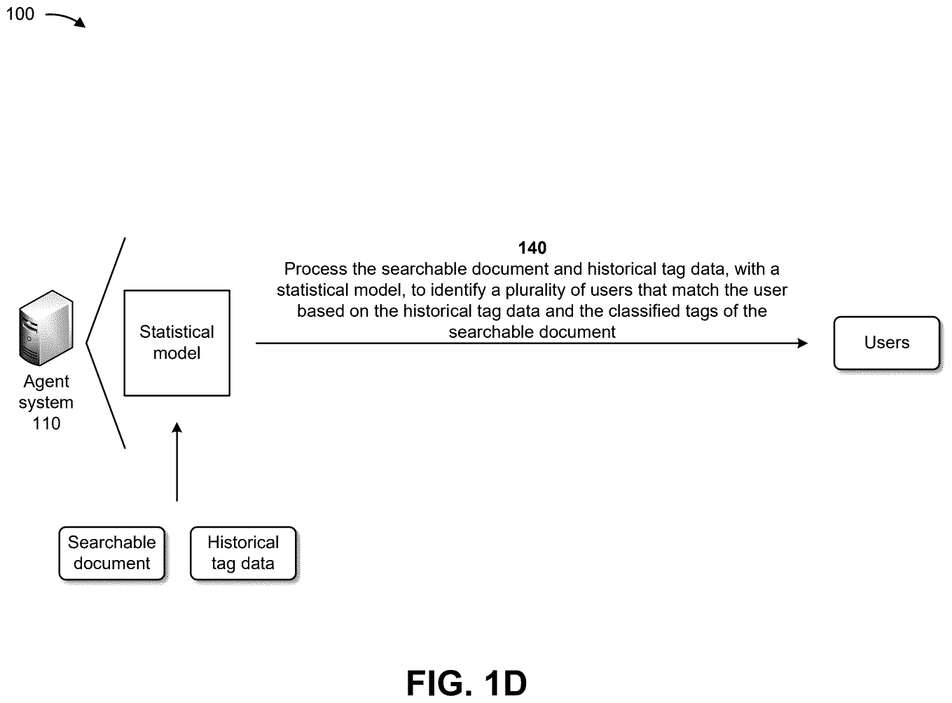

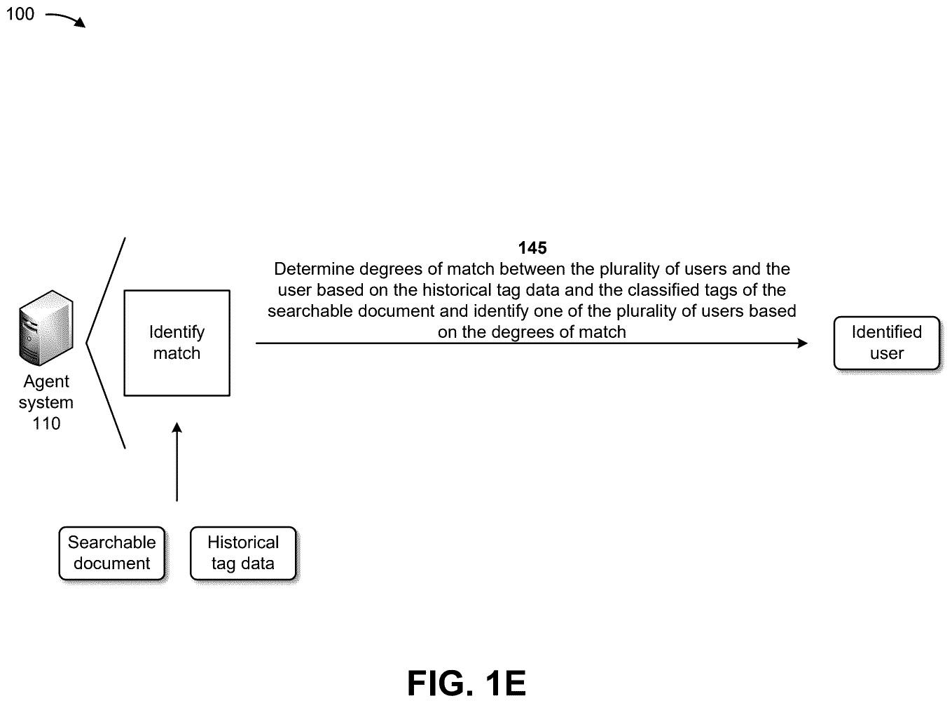

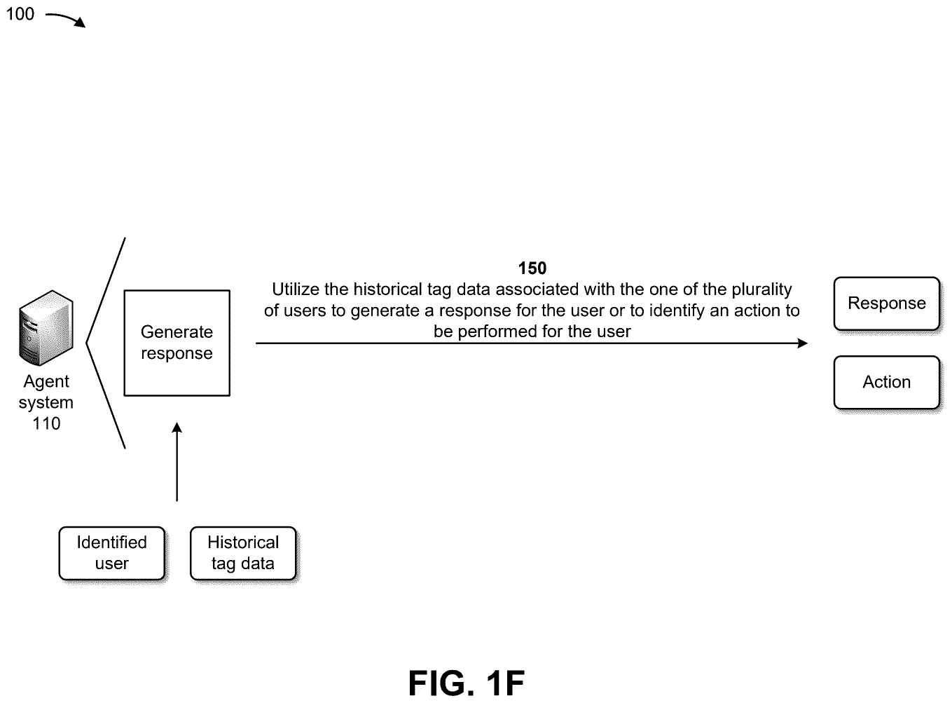

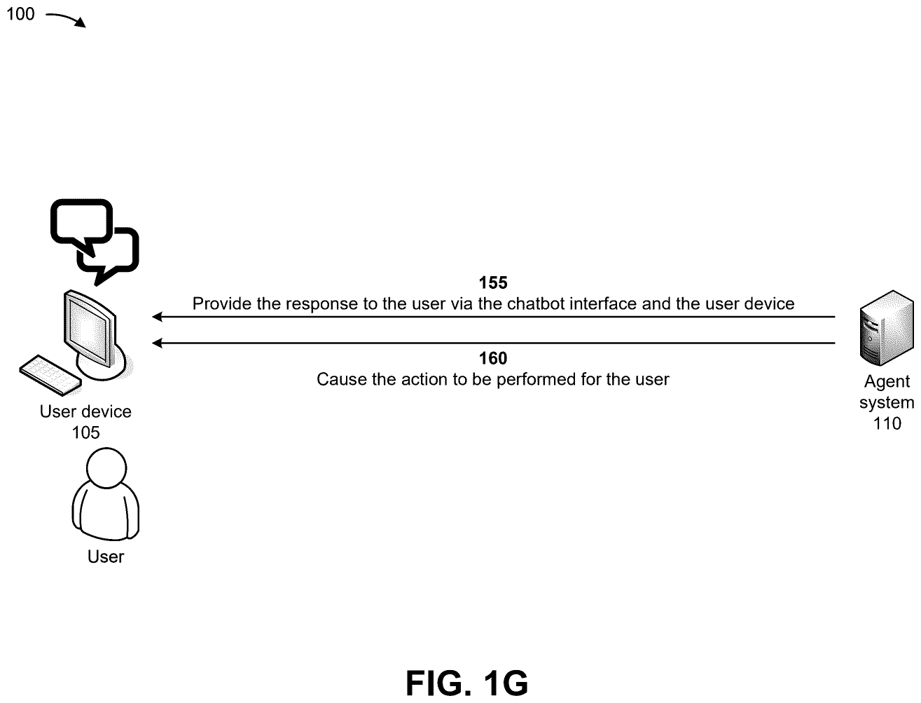

FIGS. 1A-1G are diagrams of an example 100 associated with determining patterns and providing feedback for chatbot conversations. As shown in FIGS. 1A-1G, example 100 includes a user device 105 associated with a user and an agent system 110. Although a single user device 105 is depicted in the example 100, in some implementations, the agent system 110 may be associated with multiple user devices 105. Further details of the user device 105 and the agent system 110 are provided elsewhere herein.

As shown by FIG. 1A, and by reference number 115, the agent system 110 may provide a chatbot interface to the user via the user device 105. For example, the agent system 110 may generate a chatbot interface that generates text data and/or audio data (e.g., voice data) in response to questions received from the user of the user device 105. The chatbot interface may receive text data and/or audio data from the user of the user device 105, and may convert the audio data into text data. The agent system 110 may provide the chatbot interface to the user device 105, and the user device 105 may display the chatbot interface to the user. By provisioning the chatbot interface, the agent system 110 may provide a communication medium through which users can interact with the agent system 110 using natural language input. The chatbot interface may enable users to engage in conversations that the agent system 110 will subsequently process for enhanced interaction and service provision.

As further shown in FIG. 1A, and by reference number 120, the agent system 110 may receive text data associated with a conversation of the user via the chatbot interface. For example, the user may utilize the chatbot interface to perform a conversation with the agent system 110. The user may input text data associated with the conversation via the chatbot interface and the user device 105. The user device 105 may provide the text data associated with the conversation to the agent system 110, and the agent system 110 may receive the text data associated with the conversation from the user device 105. In some implementations, the user may input audio or voice data associated with the conversation via the chatbot interface and the user device 105. The user device 105 may convert the audio or voice data into text data, and may provide the converted text data to the agent system 110. The agent system 110 may receive the converted text data from the user device 105. The text data associated with the conversation may include user-generated content entered during an interaction with the chatbot interface by the user.

As further shown in FIG. 1A, and by reference number 125, the agent system 110 may process the text data, with one or more large language models (LLMs), to generate conversation tags representative of content of the conversation. For example, the agent system 110 may utilize the analytical capabilities of the one or more LLMs to parse and understand the text data. The one or more LLMs may process the text data to derive high-level concepts and themes from the conversation, and may encapsulate the high-level concepts and the themes from the conversation in the form of the conversation tags. The agent system 110 may utilize the conversation tags to identify and categorize subject matter of the conversation, thereby facilitating subsequent searching and matching of similar user profiles and conversations.

In some implementations, the agent system 110 may utilize historical conversation data and the generated conversation tags to compare and match against incoming user queries, to identify commonalities and differences, and to offer more personalized and meaningful interactions. The one or more LLMs ability to parse and understand the text data may augment a communicative efficacy of the chatbot interface and may reduce a need for human intervention by live agents. This may enable the agent system 110 to minimize user escalations to live agents and to provide an enriched user interaction experience with the chatbot interface.

As shown in FIG. 1B, and by reference number 130, the agent system 110 may generate user attribute tags based on user data identifying activity and a profile of the user. For example, the agent system 110 may receive user data that includes activity information of the user and a user profile. The activity information may include information associated the user's interactions with the chatbot interface and various user interfaces provide by the agent system 110, past utilizations of services by the user, engagements with transactional systems by the user, and/or the like. The user profile may include information associated with demographics of the user, user preferences, an account history of the user, and other relevant metrics that define the user's characteristics and past behavior with the agent system 110.

The agent system 110 may process the user data identifying the activity and the profile of the user to create user attribute tags that accurately reflect user traits and tendencies. The user attribute tags may enable the agent system 110 to better understand the user's context and needs. For example, the user attribute tags may include a combination of categorical labels (e.g., “frequent traveler” or “budget-conscious”) derived from the user profile. Additionally, the user attribute tags may include more granular information (e.g., specific account changes or transaction frequencies) that portrays recent activity of the user. In some implementations, the agent system 110 may refine the user attribute tags using feedback loops that consider the user's responses or subsequent actions to enhance the relevance and specificity of the user attribute tags. The dynamic refinement of the user attribute tags may iteratively improve the predictive performance and personalization capabilities of the agent system 110.

The user attribute tags may enable the agent system 110 to provide more personalized user interactions and improved predictive modeling for future services, leading to heightened user satisfaction. The user attribute tags may also facilitate tailored service offerings by the agent system 110, which may maintain user engagement and potentially reduce direct human intervention by live agents.

As shown in FIG. 1C, and by reference number 135, the agent system 110 may classify the conversation tags and the user attribute tags to generate classified tags and may convert the text data and the classified tags to a searchable document with a summary and the classified tags. For example, the agent system 110 may classify the conversation tags (e.g., that are representative of the content of the conversation via the chatbot interface) and the user attribute tags (e.g., that are representative of the user's activity and profile) to generate classified tags that encapsulate aspects of the conversation and the user's attributes. In some implementations, the agent system 110 may utilize associations between the conversation tags and the user attribute tags to generate the classified tags. Alternatively, or additionally, the agent system 110 may apply, to the conversation tags and the user attribute tags, a set of classification rules or models that group or filter tags based on relevance and significance to an intent of the user and characteristics of the user.

Once the tags are classified, the agent system 110 may convert the text data from the conversation, along with the newly formed classified tags, into a searchable document. The searchable document may include a summary that concisely presents the user's interactions with the chatbot interface, and the classified tags that have been associated with the conversation. The searchable document may include a comprehensive and searchable record of user interactions through the chatbot interface. The agent system 110 may utilize the searchable document to identify patterns or trends in user interactions, which may lead to more personalized and effective responses provided by the chatbot interface to the user in future interactions. The searchable document may enable easier retrieval of specific interactions based on user attributes or conversational content by the agent system 110, thereby facilitating an improved support experience for the user. Furthermore, the summary within the searchable document may provide a quick overview, making it more efficient for the agent system 110 to understand the user's needs without having to parse through the entire conversation.

In some implementations, the agent system 110 may perform pattern matching for the conversation and the user attribute tags to determine a correspondence between the user behavior and the users profile. The conversation may be indicative of the user's behavior (e.g., what topics the user is talking about and in what tone), and the user attribute tags may be indicative of the user's profile and a condition and/or state of the user profile attributes. The pattern matching may be performed between the conversation and the user attribute tags are to track a connection and/or a relation between users with specific profiles and types of conversations associated with the users. The pattern matching may be performed between the conversation and the user attribute tags to determine what topics are more important or are trending (e.g., searching for a topic by using a topic's tags or searching for users with similar profile attributes as the user).

Examples of connecting behavior and/or topics to a user profile and/or state may include a user asking questions about a hotspot (e.g., the conversation is the user behavior), a user discussing issues with a plan (e.g., a profile attribute), such as whether the plan supports a feature, a user discussing issues with a device, a user discussing a feature related to account status (e.g., missed payments), and/or the like. Further examples of connecting behavior and/or topics to a user profile and/or state may include a user conversing about bill changes or increase, a user asking about a feature that caused the increase (e.g., a loss of a discount or an addition of a feature), a user searching for more discounts and/or credits, and/or the like. Still further examples of connecting behavior and/or topics to a user profile and/or state may include a user attempting to troubleshoot a device, whether a plan is impacted because an account is past due, whether a device was disabled during activation, whether information about the device is provided to educate the user about how to use the device, and/or the like.

As shown in FIG. 1D, and by reference number 140, the agent system 110 may process the searchable document and historical tag data, with a statistical model, to identify a plurality of users that match the user based on the historical tag data and the classified tags of the searchable document. For example, the agent system 110 may be associated with a statistical model, such as a k-means clustering model, and may process the searchable document and historical tag data with the statistical model. The statistical model may parse the historical tag data along with the classified tags of the searchable document. The historical tag data may include tag data associated with prior interactions with chatbot interfaces by a plurality of users other than the user, prior interactions with the chatbot interface by the user, and/or the like. The statistical model may utilize the historical tag data and the classified tags of the searchable document to identifying a plurality of users with similar conversation patterns or user attributes as the user. The historical tag data and the classified tags may provide insight into user behavior, user profiles, and content of conversations, since the historical tag data and the classified tags are generated based on processing conversations with one or more LLMs, extracting salient data, and creating summarizations and tags that represent user interactions.

Processing the searchable document and the historical tag data with the statistical model may enable the agent system 110 to compare the user's current interactions against a repository of data from past user interactions. The comparison may enable the agent system 110 to identify a plurality of users who have shown similar attributes or conversation patterns as the user. By analyzing a degree of match between the user and the plurality of users, the agent system 110 may effectively predict needs and intentions of the user based on identified patterns of behavior from the plurality of users.

By identifying the plurality of users that match the user, the agent system 110 may enhance user engagement with the chatbot interface and may tailor interactions of the chatbot interface more closely to user expectations and needs, thus reducing a likelihood of the user transitioning from the chatbot interface to a live agent. For example, the agent system 110 may identify actions to be performed for the user (e.g., offer a product and/or a service, provide instructions on a product and/or a service, offer a new service plan, offer discounts or credits, and/or the like) and may cause those actions to be performed, thereby providing a more responsive and interactive user experience. By identifying the plurality of users that match the user, the agent system 110 may provide for a tailored and more personal user experience, may support trend analysis to extract actionable insights, and may make operation of the chatbot interface more efficient by reducing unnecessary human intervention.

As shown in FIG. 1E, and by reference number 145, the agent system 110 may determine degrees of match between the plurality of users and the user based on the historical tag data and the classified tags of the searchable document and may identify one of the plurality of users based on the degrees of match. For example, the agent system 110 may process the searchable document and historical tag data, with the statistical model (e.g., a k-means clustering model). The statistical model may compare the historical tag data and the classified tags of the searchable document to generate comparison results. The comparison results may identify a degree of similarity or match between the historical tag data and the classified tags, which may quantify how closely conversations and user attributes of historical tag data correspond to the conversation and attributes of the user. In some implementations, the agent system 110 may rank the plurality of users based on the degrees of match between the plurality of users and the user. For example, a first user may have a degree of match of 60%, a second user may have a degree of match of 80%, a third user may have a degree of match of 50%, and fourth user may have a degree of match of 90%. In such an example, the fourth user may be ranked first, the second user may be ranked second, the first user may be ranked third, and the third user may be ranked fourth.

The agent system 110 may utilize the degrees of match in order to aid in identifying one of the plurality of users that closely resembles the user in terms of past interactions and user profile characteristics. By identifying the one of the plurality of users from the historical tag data who most closely matches the user, the agent system 110 may identify previously successful interaction strategies or responses to engage the user more effectively. In doing so, the agent system may utilize the historical tag data and user profiles to find a most suitable precedent, which may involve an analysis of trends, subjects of interest, or previously applied solutions.

For example, the agent system 110 may determine that a previous user, whose conversation involved similar tags related to billing inquiries, received a specific response that led to a successful resolution without escalating to a live agent. The agent system 110 may recommend a similar response or course of action for the current user, which is tailored based on this historical success. Additionally, the agent system 110 may receive feedback on the effectiveness of responses provided and may utilize this feedback to update the historical tag data, thereby continually refining the accuracy and relevance of future interactions.

As shown in FIG. 1F, and by reference number 150, the agent system 110 may utilize the historical tag data associated with the one of the plurality of users to generate a response for the user or to identify an action to be performed for the user. For example, the agent system 110 may analyze the historical tag data associated with the one of the plurality of users to determine trends within interactions of the one of the plurality of users with the chatbot interface. In some implementations, the agent system 110 may identify patterns that indicate subjects of interest for the one of the plurality of users. This may facilitate generation of a response that is tailored to the current user, thereby potentially maintaining or increasing user engagement with the chatbot interface. For example, the agent system 110 may utilize the historical tag data associated with the one of the plurality of users to predict subjects of interest that are likely to resonate with the current user, and may utilize the subjects of interest to generate a suitable response or identify an appropriate action to maintain the engagement of the user with the chatbot interface. The action to be performed for the user may include presenting engagement options to the user, making recommendations for specific user queries, making modifications to the conversation based on the detected intent and preferences of the user, and/or the like.

As shown in FIG. 1G, and by reference number 155, the agent system 110 may provide the response to the user via the chatbot interface and the user device 105. For example, after generating a suitable response for the user, the agent system 110 may provide the response to the user through the chatbot interface and the user device 105, which maintains user engagement and provides relevant information or solutions. In some implementations, the agent system 110 may receive feedback associated with providing the response to the user via the chatbot interface and the user device 105, and may update the historical tag data based on the feedback.

As further shown in FIG. 1G, and by reference number 160, the agent system 110 may cause the action to be performed for the user. For example, after identifying the action to be performed for the user, the agent system 110 may cause the action to be performed for the user (e.g., cause engagement options to be presented to the user, cause recommendations for specific user queries to be presented to the user, make modifications to the conversation with the user, and/or the like). In some implementations, the agent system 110 may receive feedback associated with causing the action to be performed for the user, and may update the historical tag data based on the feedback.

In this way, the agent system 110 determines patterns and provides feedback for chatbot conversations. For example, the agent system 110 may utilize LLMs and data clustering techniques to efficiently manage user chatbot inquiries and reduce workload on live agents. The agent system 110 may synthesize user attribute tags, may generate conversation tags, and may compile conversation content with a concise summary to generate a structured and searchable document. The agent system 110 may process the document and historical tag data with statistical models to correlate a user's inquiry with similar historical instances, allowing for a customized response to the user. The agent system 110 may utilize user feedback to constantly refine the historical tag data and improve future user interactions with the chatbot. By analyzing patterns and preferred interaction styles from the historical tag data, the agent system 110 may optimize user engagement and may reduce the need for direct human assistance. Thus, the agent system 110 may conserve computing resources, networking resources, and/or other resources that would have otherwise been consumed by failing to properly answer user questions with chatbots, handling user complaints due to failing to properly answer user questions appropriately and efficiently, providing incorrect recommendations based on poorly designed chatbots, providing irrelevant and inaccurate responses based on poorly designed chatbots, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

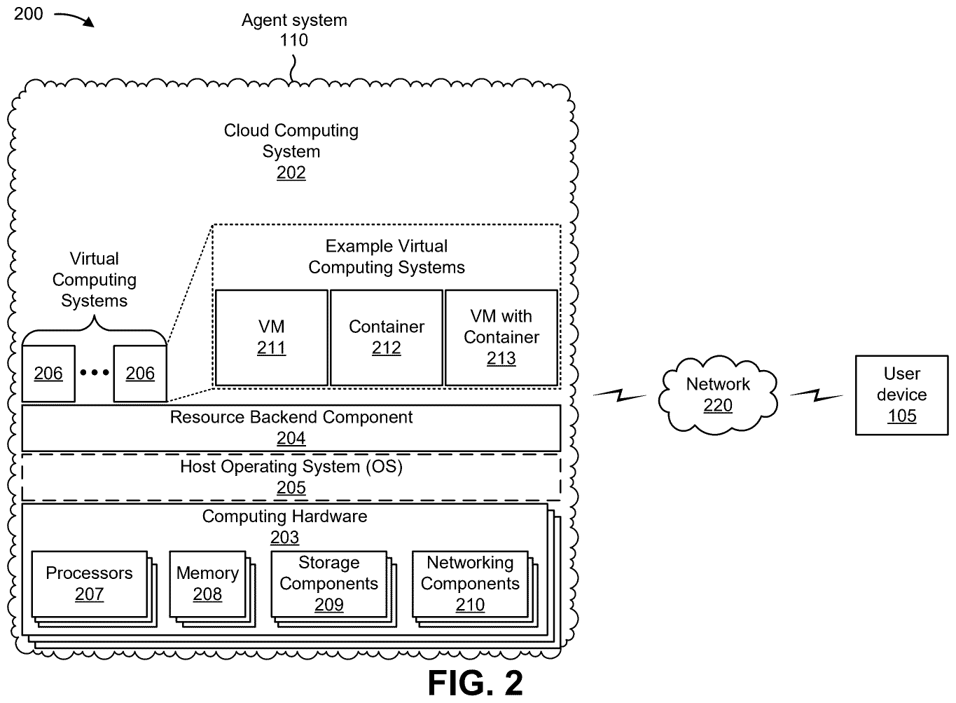

FIG. 2 is a diagram of an example environment 200 in which systems and/or methods described herein may be implemented. As shown in FIG. 2, the environment 200 may include the agent system 110, which may include one or more elements of and/or may execute within a cloud computing system 202. The cloud computing system 202 may include one or more elements 203-213, as described in more detail below. As further shown in FIG. 2, the environment 200 may include the user device 105 and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

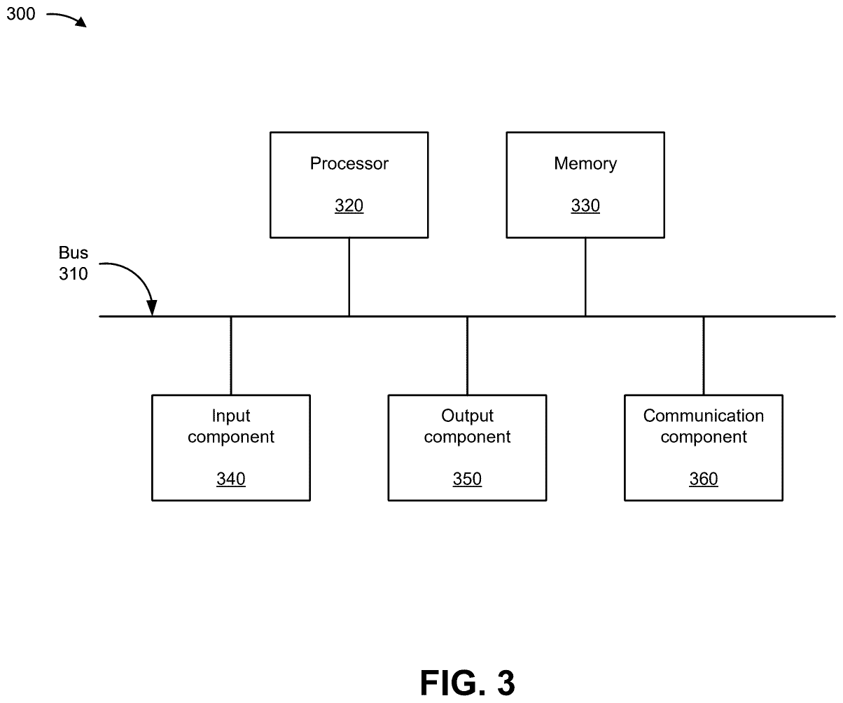

Although the agent system 110 may include one or more elements 203-213 of the cloud computing system 202, may execute within the cloud computing system 202, and/or may be hosted within the cloud computing system 202, in some implementations, the agent system 110 may not be cloud-based (e.g., may be implemented outside of a cloud computing system) or may be partially cloud-based. For example, the agent system 110 may include one or more devices that are not part of the cloud computing system 202, such as the device 300 of FIG. 3, which may include a standalone server or another type of computing device. The agent system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105 and/or the agent system 110. In some implementations, the user device 105 and/or the agent system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

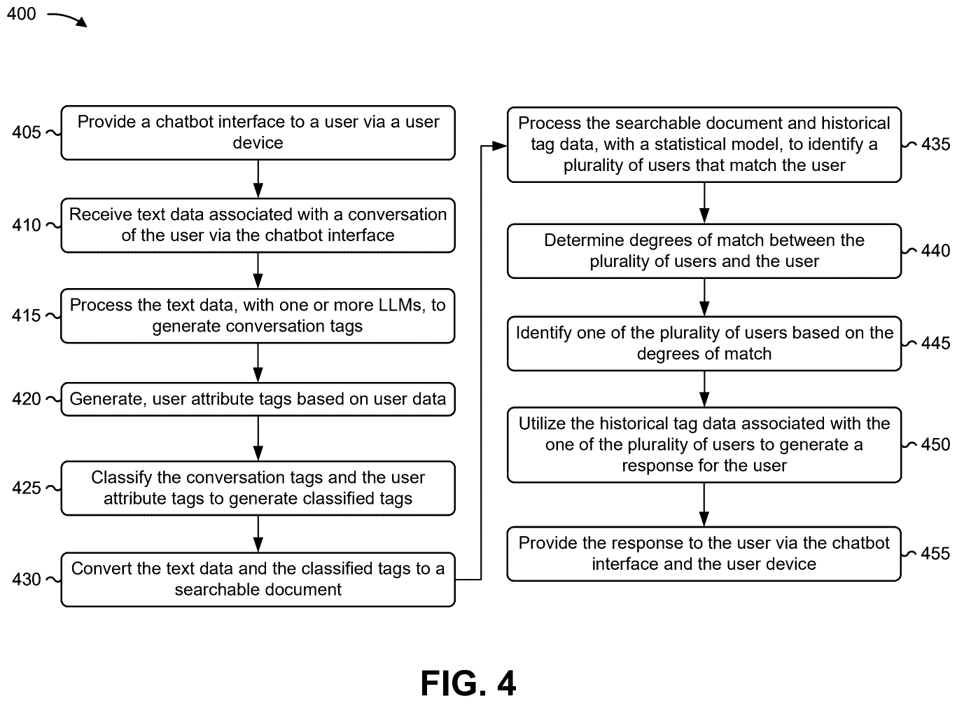

FIG. 4 is a flowchart of an example process 400 for determining patterns and providing feedback for chatbot conversations. In some implementations, one or more process blocks of FIG. 4 may be performed by a device (e.g., the agent system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include providing a chatbot interface to a user via a user device (block 405). For example, the device may provide a chatbot interface to a user via a user device, as described above.

As further shown in FIG. 4, process 400 may include receiving text data associated with a conversation of the user via the chatbot interface (block 410). For example, the device may receive text data associated with a conversation of the user via the chatbot interface, as described above.

As further shown in FIG. 4, process 400 may include processing the text data, with one or more LLMs, to generate conversation tags (block 415). For example, the device may process the text data, with one or more LLMs, to generate conversation tags representative of content of the conversation, as described above.

As further shown in FIG. 4, process 400 may include generating user attribute tags based on user data (block 420). For example, the device may generate user attribute tags based on user data identifying activity and a profile of the user, as described above.

As further shown in FIG. 4, process 400 may include classifying the conversation tags and the user attribute tags to generate classified tags (block 425). For example, the device may classify the conversation tags and the user attribute tags to generate classified tags, as described above.

As further shown in FIG. 4, process 400 may include converting the text data and the classified tags to a searchable document (block 430). For example, the device may convert the text data and the classified tags to a searchable document with a summary and the classified tags, as described above.

As further shown in FIG. 4, process 400 may include processing the searchable document and historical tag data, with a statistical model, to identify a plurality of users that match the user (block 435). For example, the device may process the searchable document and historical tag data, with a statistical model, to identify a plurality of users that match the user based on the historical tag data and the classified tags of the searchable document, as described above. In some implementations, the statistical model is a k-means clustering model.

As further shown in FIG. 4, process 400 may include determining degrees of match between the plurality of users and the user (block 440). For example, the device may determine degrees of match between the plurality of users and the user based on the historical tag data and the classified tags of the searchable document, as described above. In some implementations, determining the degrees of match between the plurality of users and the user based on the historical tag data and the classified tags of the searchable document includes determining the degrees of match between the plurality of users and the user based on a quantity of tags of the historical tag data that match the classified tags of the searchable document.

As further shown in FIG. 4, process 400 may include identifying one of the plurality of users based on the degrees of match (block 445). For example, the device may identify one of the plurality of users based on the degrees of match, as described above.

As further shown in FIG. 4, process 400 may include utilizing the historical tag data associated with the one of the plurality of users to generate a response for the user (block 450). For example, the device may utilize the historical tag data associated with the one of the plurality of users to generate a response for the user, as described above. In some implementations, the response includes a modification of the conversation of the user via the chatbot interface. In some implementations, the response maintains engagement of the user with the chatbot interface.

In some implementations, utilizing the historical tag data associated with the one of the plurality of users to generate the response for the user includes identifying one or more trends in the historical tag data associated with the one of the plurality of users, and generating the response for the user based on the one or more trends. In some implementations, utilizing the historical tag data associated with the one of the plurality of users to generate the response for the user includes utilizing the historical tag data associated with the one of the plurality of users to predict a subject of interest for the user, and generating the response for the user based on the subject of interest.

As further shown in FIG. 4, process 400 may include providing the response to the user via the chatbot interface and the user device (block 455). For example, the device may provide the response to the user via the chatbot interface and the user device, as described above.

In some implementations, process 400 includes utilizing the historical tag data associated with the one of the plurality of users to identify an action to be performed for the user, and causing the action to be performed for the user. In some implementations, causing the action to be performed includes causing engagement options to be provided to the user via the chatbot interface. In some implementations, causing the action to be performed includes determining one or more modifications for the conversation, and applying the one or more modifications to the conversation via the chatbot interface.

In some implementations, process 400 includes receiving feedback associated with providing the response to the user via the chatbot interface and the user device, and updating the historical tag data based on the feedback. In some implementations, process 400 includes determining whether the user has escalated the conversation to a live agent based on the response, and evaluating an effectiveness of the response based on whether the user escalates the conversation to the live agent. In some implementations, process 400 includes generating the historical tag data based on historical conversations associated with one or more user devices and the chatbot interface, and storing the historical tag data in a data structure.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
providing, by a device, a chatbot interface to a user via a user device;
receiving, by the device, text data associated with a conversation of the user via the chatbot interface;
processing, by the device, the text data, with one or more large language models, to generate conversation tags representative of content of the conversation;
generating, by the device, user attribute tags based on user data identifying activity and a profile of the user;
classifying, by the device, the conversation tags and the user attribute tags to generate classified tags;
converting, by the device, the text data and the classified tags to a searchable document with a summary and the classified tags;
processing, by the device, the searchable document and historical tag data, with a statistical model, to identify a plurality of users that match the user based on the historical tag data and the classified tags of the searchable document;
determining, by the device, degrees of match between the plurality of users and the user based on the historical tag data and the classified tags of the searchable document;
identifying, by the device, one of the plurality of users based on the degrees of match;
utilizing, by the device, the historical tag data associated with the one of the plurality of users to generate a response for the user; and
providing, by the device, the response to the user via the chatbot interface and the user device.

2. The method of claim 1, further comprising:
utilizing the historical tag data associated with the one of the plurality of users to identify an action to be performed for the user; and
causing the action to be performed for the user.

3. The method of claim 2, wherein causing the action to be performed comprises:
causing engagement options to be provided to the user via the chatbot interface.

4. The method of claim 2, wherein causing the action to be performed comprises:
determining one or more modifications for the conversation; and
applying the one or more modifications to the conversation via the chatbot interface.

5. The method of claim 1, wherein the statistical model is a k-means clustering model.

6. The method of claim 1, wherein the response includes a modification of the conversation of the user via the chatbot interface.

7. The method of claim 1, wherein the response maintains engagement of the user with the chatbot interface.

8. A device, comprising:
one or more processors configured to:
receive, from a user device associated with a user, text data associated with a conversation of the user,
wherein the text data is received via a chatbot interface provided to the user device;
process the text data, with one or more large language models, to generate conversation tags representative of content of the conversation;
generate user attribute tags based on user data identifying activity and a profile of the user;
classify the conversation tags and the user attribute tags to generate classified tags;
convert the text data and the classified tags to a searchable document with a summary and the classified tags;
process the searchable document and historical tag data, with a statistical model, to identify a plurality of users that match the user based on the historical tag data and the classified tags of the searchable document;
determine degrees of match between the plurality of users and the user based on the historical tag data and the classified tags of the searchable document;
identify one of the plurality of users based on the degrees of match;
utilize the historical tag data associated with the one of the plurality of users to generate a response for the user; and
provide the response to the user via the chatbot interface and the user device.

9. The device of claim 8, wherein the one or more processors, to determine the degrees of match between the plurality of users and the user based on the historical tag data and the classified tags of the searchable document, are configured to:
determine the degrees of match between the plurality of users and the user based on a quantity of tags of the historical tag data that match the classified tags of the searchable document.

10. The device of claim 8, wherein the one or more processors are further configured to:
receive feedback associated with providing the response to the user via the chatbot interface and the user device; and
update the historical tag data based on the feedback.

11. The device of claim 8, wherein the one or more processors, to utilize the historical tag data associated with the one of the plurality of users to generate the response for the user, are configured to:
identify one or more trends in the historical tag data associated with the one of the plurality of users; and
generate the response for the user based on the one or more trends.

12. The device of claim 8, wherein the one or more processors, to utilize the historical tag data associated with the one of the plurality of users to generate the response for the user, are configured to:
utilize the historical tag data associated with the one of the plurality of users to predict a subject of interest for the user; and
generate the response for the user based on the subject of interest.

13. The device of claim 8, wherein the one or more processors are further configured to:
determine whether the user has escalated the conversation to a live agent based on the response; and
evaluate an effectiveness of the response based on whether the user escalates the conversation to the live agent.

14. The device of claim 8, wherein the one or more processors are further configured to:
generate the historical tag data based on historical conversations associated with one or more user devices and the chatbot interface; and
store the historical tag data in a data structure.

15. A non-transitory computer-readable medium storing a set of instructions, the set of instructions comprising:
one or more instructions that, when executed by one or more processors of a device, cause the device to:
provide a chatbot interface to a user via a user device;
receive text data associated with a conversation of the user via the chatbot interface;
process the text data, with one or more large language models, to generate conversation tags representative of content of the conversation;
generate user attribute tags based on user data identifying activity and a profile of the user;
classify the conversation tags and the user attribute tags to generate classified tags;
process the classified tags and historical tag data, with a statistical model, to identify a plurality of users that match the user;
determine degrees of match between the plurality of users and the user based on the historical tag data and the classified tags;
identify one of the plurality of users based on the degrees of match;
utilize the historical tag data associated with the one of the plurality of users to identify an action to be performed for the user; and
cause the action to be performed for the user.

16. The non-transitory computer-readable medium of claim 15, wherein the one or more instructions, that cause the device to cause the action to be performed, cause the device to:
cause engagement options to be provided to the user via the chatbot interface.

17. The non-transitory computer-readable medium of claim 15, wherein the one or more instructions, that cause the device to cause the action to be performed, cause the device to:
determine one or more modifications for the conversation; and
apply the one or more modifications to the conversation via the chatbot interface.

18. The non-transitory computer-readable medium of claim 15, wherein the one or more instructions, that cause the device to determine the degrees of match between the plurality of users and the user based on the historical tag data and the classified tags, cause the device to:
determine the degrees of match between the plurality of users and the user based on a quantity of tags of the historical tag data that match the classified tags.

19. The non-transitory computer-readable medium of claim 15, wherein the one or more instructions further cause the device to:
receive feedback associated with causing the action to be performed for the user; and
update the historical tag data based on the feedback.

20. The non-transitory computer-readable medium of claim 15, wherein the one or more instructions, that cause the device to utilize the historical tag data associated with the one of the plurality of users to identify the action to be performed for the user, cause the device to:
identify one or more trends in the historical tag data associated with the one of the plurality of users; and
generate the action to be performed for the user based on the one or more trends.
